(19) United States
(12) Patent Application Publication
(10) Pub. No.: US 2020/0189554 A1
(43) Pub. Date: Jun. 18, 2020

(54) SERVER AND METHOD FOR MANAGING A BATTERY OF A VEHICLE

(71) Applicants: Hyundai Motor Company, Seoul (KR); Kia Motors Corporation, Seoul (KR)

(72) Inventor: Chang Ryeol Yoo, Incheon (KR)

(73) Assignees: Hyundai Motor Company, Seoul (KR); Kia Motors Corporation, Seoul (KR)

(21) Appl. No.: 16/409,170

(22) Filed: May 10, 2019

(30) Foreign Application Priority Data
Dec. 12, 2018 (KR) 10-2018-0159724

(51) Int. Cl. B60W 10/06; F02N 11/14; B60W 10/26

(52) U.S. Cl. CPC B60W 10/06; F02N 11/14; B60W 2510/244; B60W 2550/12; B60W 10/26

(57) ABSTRACT

A battery managing server of a vehicle includes a communication device and a controller. The communication device is configured to receive vehicle data and weather information and a controller. The controller is configured to calculate battery available energy and ignition required energy based on the vehicle data and the weather information. The controller is further configured to compare the battery available energy with the ignition required energy to determine whether ignition of the vehicle is possible.

### CROSS-REFERENCE TO RELATED APPLICATION

This application claims the benefit of priority to Korean Patent Application No. 10-2018-0159724, filed in the Korean Intellectual Property Office on Dec. 12, 2018, the entire contents of which are incorporated herein by reference.

### TECHNICAL FIELD

The present disclosure relates to a server and a method for managing a battery of a vehicle.

### BACKGROUND

There has been an increase in the number of in-vehicle electronic devices, such as black boxes, engine management, radio, telematics, in-car entertainment systems and the like provided in vehicles. These electronic devices may use the vehicle's battery even after the ignition is turned off and the vehicle's battery is likely to discharge when the vehicle is parked or stopped. Therefore, the battery status of charge or state of charge (SOC) of a vehicle may be lowered due to the increased electric load.

In particular, when the outside temperature of the vehicle drops below zero, for example during the winter, the SOC of the vehicle is reduced significantly. Because more ignition energy is required at a low temperature compared to room temperature, a vehicle may not start during the winter months.

It is difficult to accurately determine the battery status of the vehicle because the driving habits and driving times are different for each user. In addition, it is more difficult to determine whether the vehicle is capable of being started in a situation where the external temperature of the vehicle cannot be determined in advance.

### SUMMARY

The present disclosure has been made to solve the above-mentioned problems occurring in the prior art while advantages achieved by the prior art are maintained intact.

An aspect of the present disclosure provides a server and a method for managing a battery of a vehicle that determine whether it is possible to start the vehicle based on the vehicle data and weather information. Additionally, when it is impossible to start up the vehicle, the server and the method for managing a battery of a vehicle notify a user that it is impossible to start up the vehicle.

The technical problems to be solved by the present inventive concept are not limited to the aforementioned problems. Any other technical problems not mentioned herein will be clearly understood from the following description by those having ordinary skill in the art to which the present disclosure pertains.

According to an aspect of the present disclosure, a battery managing server of a vehicle includes a communication device configured to receive vehicle data and weather information. The battery managing server of the vehicle further includes a controller configured to calculate battery available energy and ignition required energy based on the vehicle data and the weather information. The controller is further configured to compare the battery available energy with the ignition required energy to determine whether ignition of the vehicle is possible.

According to an aspect of the present disclosure, the controller is configured to analyze a driving pattern and a parking pattern based on the vehicle data. The controller is further configured to calculate a state of charge (SOC) prediction value based on the driving pattern analysis result and the parking pattern analysis result.

According to an aspect of the present disclosure, the controller is configured to calculate a battery temperature prediction value based on a driving time and a parking time, which are obtained from the vehicle data, and an ambient temperature, which is obtained from the weather information.

According to an aspect of the present disclosure, the controller is configured to calculate the battery available energy based on the calculated SOC prediction value and the battery temperature prediction value.

According to an aspect of the present disclosure, the controller is configured to calculate the battery available energy when the driving time is less than a first arbitrary time, the parking time is not less than a second arbitrary time, and the ambient temperature is lower than an arbitrary temperature.

According to an aspect of the present disclosure, the controller is configured to allow a message for guiding a status of the battery, such as managing, handling, or controlling the status of the battery, or the like, to be output to the vehicle or an electronic device of a user based on the calculated battery available energy.

According to an aspect of the present disclosure, the controller is configured to determine that the ignition of the vehicle is impossible, when the battery available energy is less than the ignition required energy.

According to an aspect of the present disclosure, the controller is configured to allow a notification of a state where the ignition of the vehicle is impossible to be provided when it is determined that the ignition of the vehicle is impossible.

According to an aspect of the present disclosure, the controller is configured to allow a system controlling allocation of an emergency rescue vehicle or a maintenance center around the vehicle, i.e., nearest, closest, relatively nearby, in the vicinity of the vehicle, or the like, to be notified depending on the state where the ignition of the vehicle is impossible.

According to an aspect of the present disclosure, a method for managing a battery of a vehicle includes receiving vehicle data and weather information. The method for managing the battery of the vehicle further includes calculating battery available energy and ignition required energy based on the vehicle data and the weather information. The method for managing the battery of the vehicle also includes comparing the battery available energy with the ignition required energy to determine whether ignition of the vehicle is possible.

According to an aspect of the present disclosure, the calculating of the battery available energy includes calculating an SOC prediction value based on the vehicle data and calculating a battery temperature prediction value based on the vehicle data and the weather information.

According to an aspect of the present disclosure, the calculating of the SOC prediction value includes analyzing a driving pattern based on the vehicle data and analyzing a vehicle parking pattern based on the vehicle data.

According to an aspect of the present disclosure, the calculating of the battery temperature prediction value includes calculating a battery temperature prediction value based on a driving time and a parking time, which are obtained from the vehicle data, and an ambient temperature, which is obtained from the weather information.

According to an aspect of the present disclosure, the calculating of the battery available energy includes calculating the battery available energy when the driving time is less than a first arbitrary time, the parking time is not less than a second arbitrary time, and the ambient temperature is lower than an arbitrary temperature.

According to an aspect of the present disclosure, the method further includes allowing a message for guiding a status of the battery, such as managing, handling, or controlling the status of the battery, or the like, to be output to the vehicle or an electronic device of a user based on the battery available energy.

According to an aspect of the present disclosure, the determining of whether ignition of the vehicle is possible includes determining that the ignition of the vehicle is impossible, when the battery available energy is less than the ignition required energy.

According to an aspect of the present disclosure, the method further includes allowing a notification of a state where the ignition of the vehicle is impossible, to be provided, when it is determined that the ignition of the vehicle is impossible.

According to an aspect of the present disclosure, the method further includes allowing a system controlling allocation of an emergency rescue vehicle or a maintenance center around the vehicle to be notified depending on the state where the ignition of the vehicle is impossible.

### BRIEF DESCRIPTION OF THE DRAWINGS

The above and other objects, features and advantages of the present disclosure will be more apparent from the following detailed description taken in conjunction with the accompanying drawings:

FIG. 1 is a block diagram illustrating a battery managing server of a vehicle, according to an embodiment of the present disclosure;

FIG. 2 is a graph illustrating an SOC according to a parking time and temperature, according to an embodiment of the present disclosure;

FIG. 3 is a graph illustrating a condition for calculating battery available energy, according to an embodiment of the present disclosure;

FIG. 4 is a graph illustrating calculated battery available energy, according to an embodiment of the present disclosure;

FIG. 5 is a graph illustrating ignition required energy according to temperature, according to an embodiment of the present disclosure;

FIG. 6 is a diagram illustrating a message for guiding a battery status, according to an embodiment of the present disclosure;

FIG. 7 is a flowchart illustrating a battery managing method of a vehicle, according to an embodiment of the present disclosure;

FIG. 8 is a flowchart illustrating a method of calculating an SOC prediction value, according to an embodiment of the present disclosure;

FIG. 9 is a flowchart illustrating a method of calculating a battery temperature prediction value, according to an embodiment of the present disclosure;

FIG. 10 is a flowchart illustrating a method for managing a battery, according to another embodiment of the present disclosure;

FIG. 11 is a flowchart illustrating a method for managing a battery, according to still another embodiment of the present disclosure; and

FIG. 12 is a block diagram illustrating a configuration of a computing system performing a method, according to an embodiment of the present disclosure.

### DETAILED DESCRIPTION

Hereinafter, various embodiments of the present disclosure are described in detail with reference to the accompanying drawings. In the drawings, the same reference numerals are used throughout to designate the same or equivalent elements. In addition, a detailed description of well-known features or functions is not included in order to not unnecessarily obscure the gist of the present disclosure.

In describing elements of various embodiments of the present disclosure, the terms first, second, A, B, (a), (b), and the like may be used herein. These terms are only used to distinguish one element from another element, but do not limit the corresponding elements irrespective of the order or priority of the corresponding elements. Furthermore, unless otherwise defined, all terms including technical and scientific terms used herein are to be interpreted as is customary in the art to which this disclosure belongs. It will be understood that terms used herein should be interpreted as having a meaning that is consistent with their meaning in the context of the present disclosure and the relevant art and will not be interpreted in an idealized or overly formal sense unless expressly so defined herein.

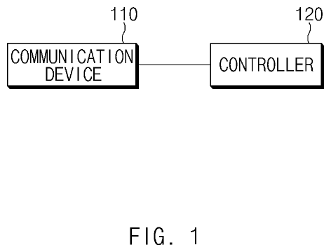

FIG. 1 is a block diagram illustrating a battery managing server of a vehicle, according to an embodiment of the present disclosure.

As illustrated in FIG. 1, a battery managing server of a vehicle according to an embodiment of the present disclosure may include a communication device 110 and a controller 120.

The communication device 110 may communicate with a vehicle, a user's electronic device, and an external weather information system. In this example, the user's electronic device may include a portable terminal such as a smartphone, an electronic pad, a notebook computer, or the like.

The communication device 110 may be connected to the vehicle and to the electronic device in a wired or wireless manner. The communication device 110 may be connected by a USB cable when being connected by wire. The communication device 110 may be connected by Wi-Fi direct communication when being connected wirelessly. According to an embodiment, the communication device 110 may be connected through short-range wireless communication such as wireless broadband, World Interoperability for Microwave Access (Wimax), Bluetooth, Radio Frequency Identification (RFID), infrared communication (infrared data association (IrDA)), Ultra Wideband (UWB), ZigBee, or the like.

The communication device 110 may receive vehicle data from a vehicle. In this example, the vehicle data may include the SOC of a battery, the temperature of the battery liquid, the parking and stopping time of the vehicle, the driving time of the vehicle, the location information of the vehicle, the usage amount of an electronic device in the vehicle, or the like.

The communication device 110 may receive weather alerts, short-term/long-term weather forecasts, and weather information from a weather information system in real time.

The controller 120 may control the overall operation of the battery managing server of the vehicle.

The controller 120 may calculate an SOC prediction value based on the vehicle data received from the vehicle.

The controller 120 may configure a DATA MART by classifying and processing only necessary information among the vehicle data received from the vehicle.

The controller 120 may perform distributed-processing on the DATA MART to store the distributed-processed DATA MART.

The controller 120 performs a driving pattern analysis and a parking pattern analysis of the vehicle based on the distributed-processed DATA MART.

The driving pattern analysis may include performing clustering analysis on vehicle data including the driving time, the driving area, and the driving characteristics of the user of the vehicle. The driving pattern analysis may further include analyzing the SOC that varies depending on the vehicle type, engine characteristics, and temperature for each classified group.

The parking pattern analysis may include performing clustering analysis on vehicle data, including the parking time of the vehicle and the usage of an in-vehicle electronic device. The parking pattern analysis may further include analyzing the SOC that varies depending on the vehicle type, engine characteristics, and temperature for each classified group.

The controller 120 may calculate the SOC prediction value through correlation analysis of the driving pattern analysis result and the parking pattern analysis result.

The controller 120 may periodically perform driving pattern analysis and parking pattern analysis to improve the reliability of the SOC prediction value.

The controller 120 may calculate the battery temperature prediction value based on the vehicle data received from the vehicle and the weather information received from a weather information system. In this example, the weather information received from the weather information system may include past temperature data for each region, monthly past temperature data, weather forecast data, and the like.

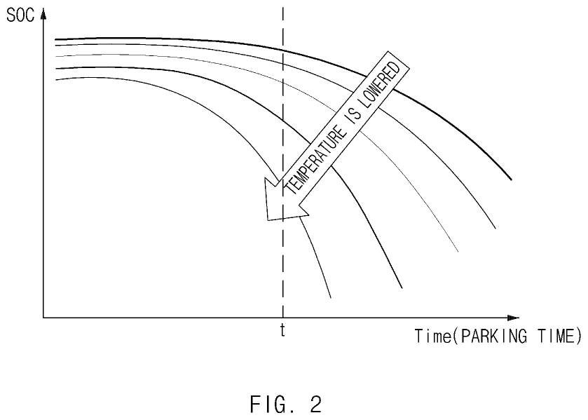

The controller 120 may obtain the driving time and the parking time based on the received vehicle data, may obtain the temperature around the vehicle, i.e., surrounding, nearby, in the vicinity of the vehicle, or the like, based on the received weather information, and may calculate the battery temperature prediction value. In this regard, a description will be given in detail with reference to FIG. 2.

FIG. 2 is a graph illustrating an SOC according to a parking time and temperature, according to an embodiment of the present disclosure.

As illustrated in FIG. 2, it may be identified that the SOC decreases as the temperature around the vehicle decreases, when the parking time ‘t’ has elapsed.

In other words, as the temperature around the vehicle decreases, the temperature of the electrolyte inside the battery may decrease, and thus it is identified that the SOC decreases.

The controller 120 may calculate the battery temperature prediction value based on the driving time, the parking time, and the temperature around the vehicle, using the characteristic that the SOC decreases depending on the decrease of the ambient temperature illustrated in FIG. 2.

More specifically, the controller 120 may generate a temperature change function of the battery electrolyte and may calculate a battery temperature prediction value by reflecting the temperature around the vehicle received from the weather information system.

The controller 120 may calculate the battery available energy based on the calculated SOC prediction value and the calculated battery temperature prediction value. In this example, the battery available energy may mean the currently available battery energy.

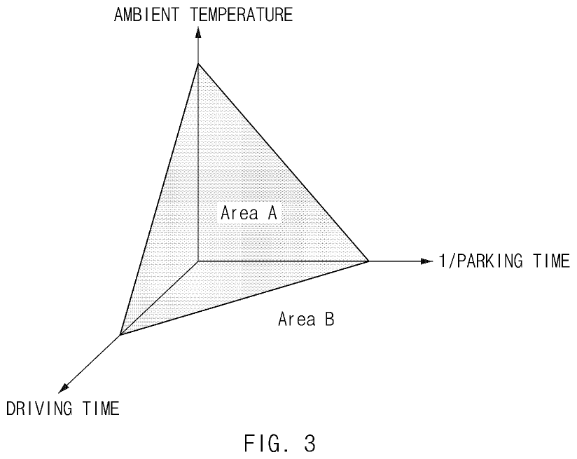

According to an embodiment of the present disclosure, the controller 120 may calculate the battery available energy with reference to FIG. 3.

FIG. 3 is a graph illustrating a condition for calculating battery available energy, according to an embodiment of the present disclosure.

As illustrated in FIG. 3, each axis may indicate a driving time, 1/parking time, and ambient temperature.

The controller 120 may allow the battery available energy to be calculated, in the ‘Area A’ where the driving time is less than the first arbitrary time, the parking time is not less than the second arbitrary time, and the ambient temperature is lower than the arbitrary temperature.

The controlling of the battery available energy to be calculated in the ‘Area A’ is the reason that a problem in the ignition operation occurs. The problem in the ignition operation occurs because the SOC is maintained below the reference value as the ambient temperature is maintained below a specific value and the temperature of the battery is maintained below the reference value in the ‘Area A’.

The controller 120 may allow the battery available energy not to be calculated in the ‘Area B’ where the driving time is greater than the first arbitrary time, the parking time is less than the second arbitrary time, and the ambient temperature exceeds the arbitrary temperature.

The controlling of the battery available energy not calculated in the ‘Area B’ is the reason that a problem in the ignition operation does not occur. The problem in the ignition operation does not occur because the SOC is maintained above the reference value as the ambient temperature is maintained above a specific value and the temperature of the battery is maintained above the reference value in the ‘Area B’.

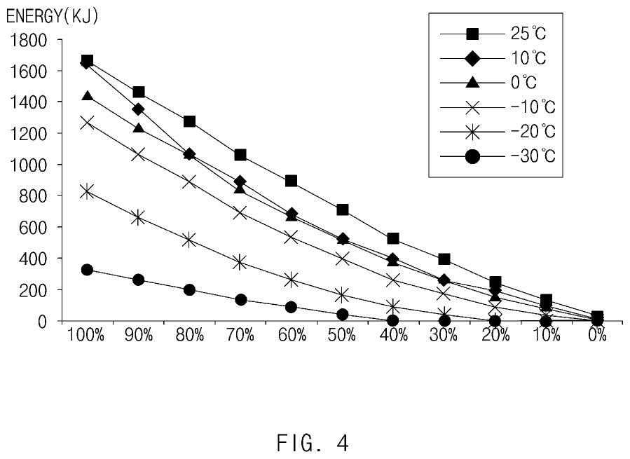

The calculated battery available energy will be described in more detail with reference to FIG. 4.

FIG. 4 is a graph illustrating calculated battery available energy, according to an embodiment of the present disclosure.

As illustrated in FIG. 4, an X axis denotes SOC, a Y axis denotes battery available energy and the battery available energy according to the SOC from −30 degrees to 25 degrees is illustrated.

There is a large difference between the battery available energy at 25 degrees and the battery available energy at −30 degrees when the SOC is 100%. As a result, it is understood that the battery available energy is lowered as the ambient temperature is lowered.

The controller 120 may calculate ignition required energy based on vehicle data and weather information. For example, the controller 120 may calculate the ignition required energy, which is required for ignition depending on the parking time and temperature, based on the current location of the vehicle.

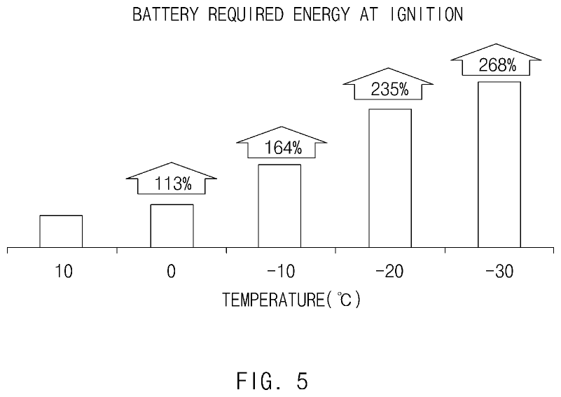

The ignition required energy will be described in more detail with reference to FIG. 5.

FIG. 5 is a graph illustrating ignition required energy according to temperature, according to an embodiment of the present disclosure.

As illustrated in FIG. 5, an X axis denotes temperature, a Y axis denotes ignition required energy, and the ignition required energy from 10 degrees to −30 degrees is illustrated.

The ignition required energy significantly increases as the temperature is lowered. For example, when the ambient temperature is −30° C., the ignition required energy that is required is about three times that required to turn on the engine compared with turning on an engine at room temperature.

The controller 120 may compare the battery available energy with the ignition required energy to determine whether ignition is possible.

The controller 120 may calculate the calculated battery available energy as a percentage and may output a message for guiding the battery status to the vehicle or a user's electronic device.

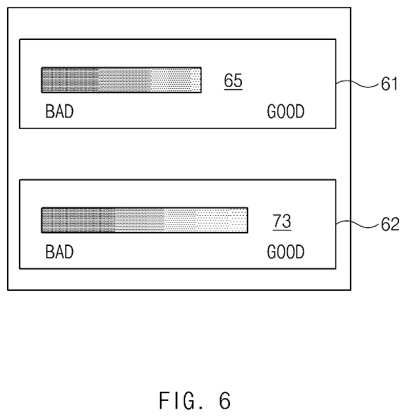

FIG. 6 is a diagram illustrating a message for guiding a battery status, according to an embodiment of the present disclosure.

As illustrated in FIG. 6, the controller 120 may output a value 61 from calculating the battery available energy calculated from a host vehicle as a percentage and a value 62 from calculating the average of the battery available energy of other vehicles, which are driving under the same condition as the driving condition of the host vehicle, as a percentage together, when the controller 120 outputs a message for guiding the battery status.

The controller 120 may determine that ignition is possible, when the battery available energy is greater than the ignition required energy. The controller 120 may determine that ignition is not possible, when the battery available energy is less than the ignition required energy.

When it is determined that ignition is not possible, the controller 120 may allow a user to be notified with a message according to the determination that the ignition is impossible. For example, the controller 120 may allow an electronic device of the user to transmit a message associated with a battery check.

Furthermore, when the controller 120 determines that ignition is impossible, the controller 120 may allow the maintenance center around the vehicle to be notified that there is a vehicle determined as not capable of being started. Through such advanced notice, the control unit may allow the maintenance center to rapidly maintain, fix, or repair a vehicle determined as not capable of being started, when the vehicle visits the maintenance center around the vehicle.

Furthermore, when the controller 120 determines that ignition is impossible, the controller 120 may allow a system controlling the allocation of an emergency rescue vehicle to be notified that there is a vehicle determined as not capable of being started.

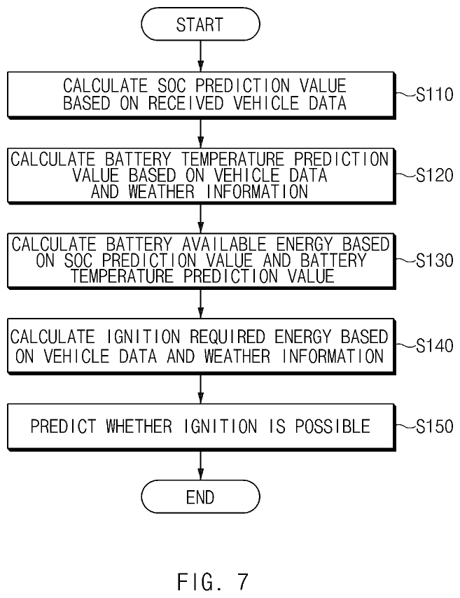

FIG. 7 is a flowchart illustrating a battery managing method of a vehicle, according to an embodiment of the present disclosure.

As illustrated in FIG. 7, in operation S110, the controller 120 calculates an SOC prediction value based on the vehicle data received from a vehicle.

In operation S120, the controller 120 calculates the battery temperature prediction value based on the vehicle data and the weather information received from a weather information system.

In operation S130, the controller 120 calculates the battery available energy based on the calculated SOC prediction value and the calculated battery temperature prediction value.

In operation S140, the controller 120 calculates the ignition required energy required for ignition based on the vehicle data and the weather information. In operation S140, the controller 120 may calculate the ignition required energy based on the parking time and the current temperature.

In operation S150, the controller 120 compares the battery available energy calculated in operation S130 and the ignition required energy calculated in operation S140 to determine whether ignition is possible.

In operation 150, the controller 120 may determine that ignition is possible, when the calculated battery available energy is greater than the calculated ignition required energy. In operation 150, the controller 120 may determine that ignition is not possible, when the calculated battery available energy is less than the calculated ignition required energy.

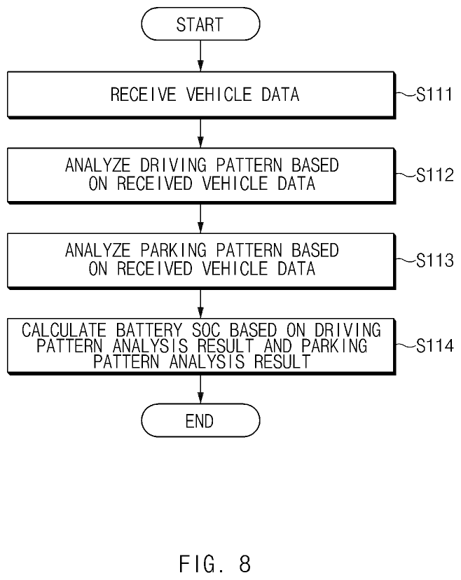

FIG. 8 is a flowchart illustrating a method of calculating an SOC prediction value, according to an embodiment of the present disclosure.

As illustrated in FIG. 8, in operation S111, the communication device 110 receives vehicle data from a vehicle. In operation S111, the controller 120 may configure a DATA MART by classifying and processing only necessary information among the vehicle data received from the vehicle. The controller 120 may perform distributed-processing on the DATA MART to store the distributed-processed DATA MART.

In operation S112, the controller 120 performs a driving pattern analysis of the vehicle based on the distributed-processed DATA MART. In operation S112, the controller 120 may perform clustering analysis on vehicle data including the driving time, the driving area, and the driving characteristics of the user of the vehicle and may analyze the SOC that varies depending on the vehicle type, engine characteristics, and temperature for each classified group.

In operation S113, the controller 120 performs a parking pattern analysis of the vehicle based on the distributed-processed DATA MART. In operation S113, the controller 120 may perform clustering analysis on vehicle data, including the parking time of the vehicle and the usage of an in-vehicle electronic device. The controller may further analyze the SOC that varies depending on the vehicle type, engine characteristics, and temperature for each classified group.

In operation S114, the controller 120 calculates the SOC prediction value through correlation analysis of the driving pattern analysis result and the parking pattern analysis result.

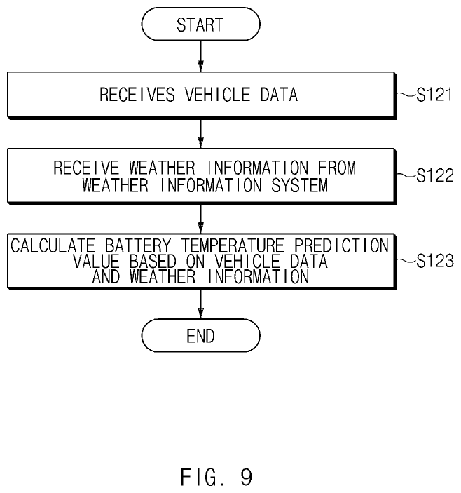

FIG. 9 is a flowchart illustrating a method of calculating a battery temperature prediction value, according to an embodiment of the present disclosure.

As illustrated in FIG. 9, in operation S121, the controller 120 receives vehicle data from a vehicle. In operation S121, the controller 120 may obtain driving time and parking time based on vehicle data.

In operation S122, the controller 120 receives weather information from a weather information system. In operation S122, the controller 120 may include past temperature data for each region, monthly past temperature data, weather forecast data, and the like. The controller 120 may further obtain the temperature around the vehicle based on the received weather information.

In operation S123, the controller 120 calculates the battery temperature prediction value based on the extracted vehicle data and the extracted weather information.

In operation 123, the controller 120 may extract the driving time and the parking time, may extract the temperature around the vehicle from the received weather information, and may calculate the battery temperature prediction value. In operation 123, the controller 120 may generate a temperature change function of the battery electrolyte and may calculate a battery temperature prediction value by reflecting the temperature around the vehicle extracted from the received weather information.

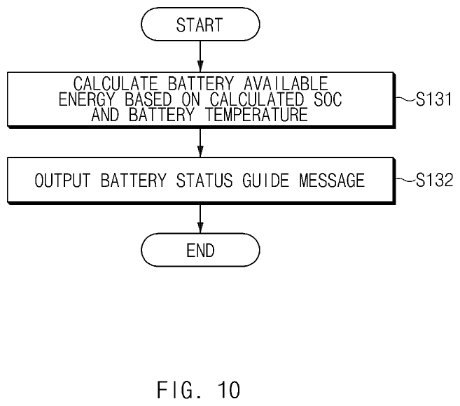

FIG. 10 is a flowchart illustrating a method for managing a battery, according to another embodiment of the present disclosure.

In operation S131, the controller 120 calculates the battery available energy based on the calculated SOC prediction value and the calculated battery temperature prediction value. In this example, the battery available energy may mean the currently available battery energy. In operation S131, the controller 120 may allow the battery available energy to be calculated when the driving time is less than the first arbitrary time, the parking time is not less than the second arbitrary time, and the ambient temperature is lower than the arbitrary temperature.

In operation S132, the controller 120 allows a battery status guide message to be output based on the battery available energy.

In operation S132, the controller 120 may allow the battery status guide message to be output to a vehicle or an electronic device of a user. In addition, the controller 120 may output a value from calculating the battery available energy calculated from the host vehicle as a percentage. The controller 120 may also output a value from calculating the average of the battery available energy of other vehicles, which are driving under the same condition as the driving condition of the host vehicle, as a percentage together.

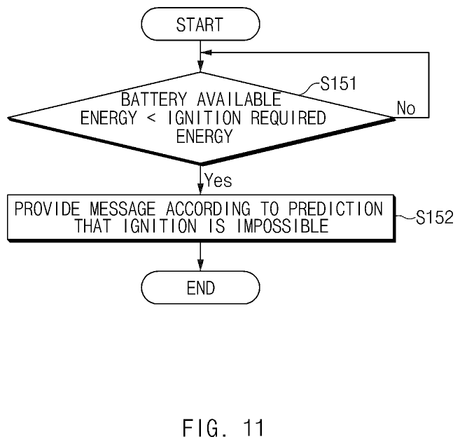

FIG. 11 is a flowchart illustrating a method for managing a battery, according to still another embodiment of the present disclosure.

In operation S151, the controller 120 determines whether the battery available energy calculated in operation S130 is less than the ignition required energy calculated in operation S140. The controller 120 may determine that ignition is impossible when it is determined in S151 that the battery available energy calculated in operation S130 is less than the ignition required energy calculated in operation S140.

In operation S152, when determining that ignition is not possible, the controller 120 may provide a notification of a message according to the determination that the ignition is impossible.

In operation S152, the controller 120 may make it possible to transmit a battery check-related message to an electronic device of a user. The controller 120 may further make it possible to notify the maintenance center around the vehicle that there is a vehicle determined as not capable of being started. The controller 120 may make it possible to notify a system controlling the allocation of an emergency rescue vehicle that there is a vehicle determined as not capable of being started.

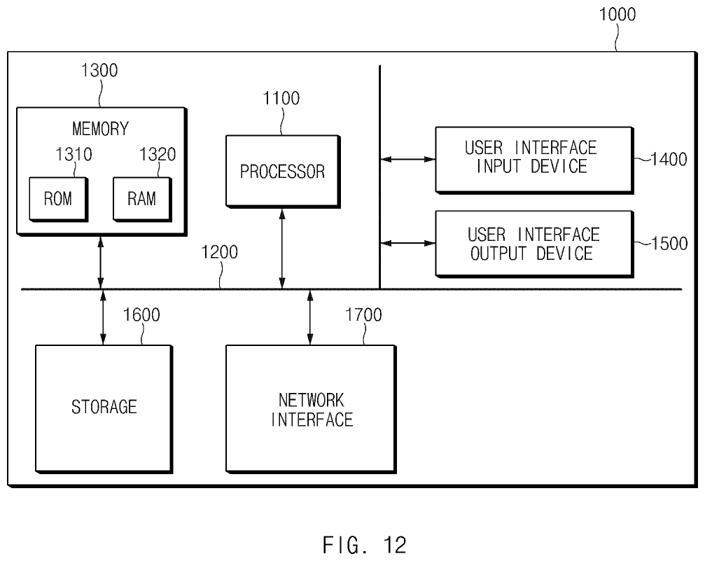

FIG. 12 is a block diagram illustrating a configuration of a computing system performing a method, according to an embodiment of the present disclosure.

Referring to FIG. 12, a computing system 1000 may include at least one processor 1100, a memory 1300, a user interface input device 1400, a user interface output device 1500, storage 1600, and a network interface 1700, which are connected with each other via a bus 1200.

The processor 1100 may be a central processing unit (CPU) or a semiconductor device that processes instructions stored in the memory 1300 and/or the storage 1600. Each of the memory 1300 and the storage 1600 may include various types of volatile or nonvolatile storage media. For example, the memory 1300 may include a read only memory (ROM) 1310 and a random access memory (RAM) 1320.

Thus, the operations of the methods or algorithms described in connection with the embodiments disclosed in the specification may be directly implemented with a hardware module, a software module, or a combination of the hardware module and the software module, which is executed by the processor 1100. The software module may reside on a storage medium (i.e., the memory 1300 and/or the storage 1600) such as a RAM, a flash memory, a ROM, an erasable and programmable ROM (EPROM), an electrically EPROM (EEPROM), a register, a hard disc, a removable disc, or a compact disc-ROM (CD-ROM). The storage medium may be coupled to the processor 1100. The processor 1100 may read out information from the storage medium and may write information in the storage medium. Alternatively, the storage medium may be integrated with the processor 1100. The processor and storage medium may reside in an application specific integrated circuit (ASIC). The ASIC may reside in a user terminal. Alternatively, the processor and storage medium may reside as a separate component in the user terminal.

Hereinabove, although the present disclosure has been described with reference to various embodiments and the accompanying drawings, the present disclosure is not limited thereto, but may be variously modified and altered by those having ordinary skill in the art to which the present disclosure pertains without departing from the spirit and scope of the present disclosure claimed in the following claims.

Therefore, embodiments of the present disclosure are not intended to limit the technical spirit of the present disclosure. Embodiments of the present disclosure are provided only for illustrative purposes. The scope of protection of the present disclosure should be construed by the attached claims. All equivalents thereof should be construed as being included within the scope of the present disclosure.

According to an embodiment of the present disclosure, a server and a method for managing a battery of a vehicle may determine whether it is possible to start a vehicle based on vehicle data and weather information. For the user's convenience, when it is impossible to start the vehicle or to allow an emergency rescue vehicle to be dispatched, the user is notified that it is impossible to start the vehicle.

Hereinabove, although the present disclosure has been described with reference to various embodiments and the accompanying drawings, the present disclosure is not limited thereto, but may be variously modified and altered by those having ordinary skill in the art to which the present disclosure pertains without departing from the spirit and scope of the present disclosure claimed in the following claims.

What is claimed is:

1. A battery managing server of a vehicle, the server comprising:
a communication device configured to receive vehicle data and weather information; and
a controller, wherein the controller is configured to:
calculate battery available energy and ignition required energy based on the vehicle data and the weather information; and
compare the battery available energy with the ignition required energy to determine whether ignition of the vehicle is possible.

2. The server of claim 1, wherein the controller is configured to:
analyze a driving pattern and a parking pattern based on the vehicle data; and
calculate a state of charge (SOC) prediction value based on the driving pattern analysis result and the parking pattern analysis result.

3. The server of claim 2, wherein the controller is configured to:
calculate a battery temperature prediction value based on a driving time and a parking time, which are obtained from the vehicle data, and an ambient temperature, which is obtained from the weather information.

4. The server of claim 3, wherein the controller is configured to:
calculate the battery available energy based on the calculated SOC prediction value and the battery temperature prediction value.

5. The server of claim 3, wherein the controller is configured to:
calculate the battery available energy when the driving time is less than a first arbitrary time, the parking time is not less than a second arbitrary time, and the ambient temperature is lower than an arbitrary temperature.

6. The server of claim 1, wherein the controller is configured to:
allow a message for guiding a status of battery to be output to the vehicle or an electronic device of a user based on the calculated battery available energy.

7. The server of claim 1, wherein the controller is configured to:
when the battery available energy is less than the ignition required energy, determine that the ignition of the vehicle is impossible.

8. The server of claim 7, wherein the controller is configured to:
when it is determined that the ignition of the vehicle is impossible, allow a notification of a state where the ignition of the vehicle is impossible, to be provided.

9. The server of claim 8, wherein the controller is configured to:
allow a system controlling allocation of an emergency rescue vehicle or a maintenance center around the vehicle to be notified depending on the state where the ignition of the vehicle is impossible.

10. A method for managing a battery of a vehicle, the method comprising:
receiving vehicle data and weather information;
calculating battery available energy and ignition required energy based on the vehicle data and the weather information; and
comparing the battery available energy with the ignition required energy to determine whether ignition of the vehicle is possible.

11. The method of claim 10, wherein the calculating of the battery available energy includes:
calculating a state of charge (SOC) prediction value based on the vehicle data; and
calculating a battery temperature prediction value based on the vehicle data and the weather information.

12. The method of claim 11, wherein the calculating of the SOC prediction value includes:
analyzing a driving pattern based on the vehicle data; and
analyzing a vehicle parking pattern based on the vehicle data.

13. The method of claim 11, wherein the calculating of the battery temperature prediction value includes:
calculating a battery temperature prediction value based on a driving time and a parking time, which are obtained from the vehicle data, and an ambient temperature, which is obtained from the weather information.

14. The method of claim 13, wherein the calculating of the battery available energy includes:
calculating the battery available energy when the driving time is less than a first arbitrary time, the parking time is not less than a second arbitrary time, and the ambient temperature is lower than an arbitrary temperature.

15. The method of claim 10, further comprising:
allowing a message for guiding a status of the battery to be output to the vehicle or an electronic device of a user based on the battery available energy.

16. The method of claim 10, wherein, the determining of whether ignition of the vehicle is possible includes:
determining that the ignition of the vehicle is impossible, when the battery available energy is less than the ignition required energy.

17. The method of claim 16, further comprising:
when it is determined that the ignition of the vehicle is impossible, allowing a notification of a state where the ignition of the vehicle is impossible, to be provided.

18. The method of claim 17, further comprising:
allowing a system controlling allocation of an emergency rescue vehicle or a maintenance center around the vehicle to be notified depending on the state where the ignition of the vehicle is impossible.
